(19) United States
(12) Patent Application Publication
(10) Pub. No.: US 2022/0146679 A1
(43) Pub. Date: May 12, 2022

(54) LASER SCANNING DEVICE AND METHOD FOR THE THREE-DIMENSIONAL MEASUREMENT OF A SETTING FROM A GREAT DISTANCE

(71) Applicant: JENOPTIK Optical Systems GmbH, Jena (DE)

(72) Inventor: Frank SCHNEIDER, Mohlsdorf-Teichwolframsdorf (DE)

(21) Appl. No.: 17/438,283

(22) PCT Filed: Mar. 10, 2020
(86) PCT No.: PCT/DE2020/100164

§ 371 Date: Sep. 10, 2021

(30) Foreign Application Priority Data
Mar. 13, 2019 (DE) 10 2019 106 411.2

(51) Int. Cl. G01S 17/89; G01S 7/481; G01S 7/484; G01B 11/22

(52) U.S. Cl. CPC G01S 17/89; G01B 11/22; G01S 7/484; G01S 7/4817

(57) ABSTRACT

A method for the three-dimensional measurement of a setting from a great distance, and a laser scanning device suitable for this purpose. The field of view of a laser scanning device is divided into virtual receiver cells forming a row or a matrix which, in a scanning direction, are many times smaller than a measurement field within the field of view to which a laser pulse is applied. A receiver signal is formed from the portion of the laser pulse that is reflected from a measurement field and detected, and the receiver signal is digitized and allocated to each virtual receiver cell that lies in the measurement field in question. The virtual receiver cells are thus allocated multiple digitized receiver signals from which an accumulated receiver signal is formed.

### PRIORITY CLAIM

The present application is a National Phase entry of PCT Application No. PCT/DE2020/100164, filed Mar. 10, 2020, which claims priority from German Patent Application 10 2019 106 411.2, filed Mar. 13, 2019, the disclosures of which are hereby incorporated by reference herein in their entirety.

### FIELD OF THE INVENTION

The invention relates to a laser scanning device and a related method.

### DESCRIPTION OF THE PRIOR ART

The three-dimensional measurement of the surroundings is becoming increasingly important in the industrial and automotive environment. In this context, 3D cameras are increasingly being replaced by laser scanning devices, which are required to a greater or lesser extent, depending on the intended use, to have a large field of view, a high spatial resolution, a long range and/or a large dynamic range. These requirements are fundamentally contradictory to each other. It is also imperative that the parameters of the laser pulses emitted by the laser scanning device are selected so that their energy is within the eye safety range.

Known laser scanning devices, such as those disclosed in the aforementioned EP 2,182,377 B1, and thus also a laser scanning device according to the invention, comprise a transmitter unit for transmitting laser pulses, a receiver unit for receiving a respective portion of a laser pulse reflected at a target object, a memory and evaluation unit for determining distances from receiver signals formed by the receiver unit, and a movable deflection unit for one- or two-dimensional deflection of the radiation direction of the laser pulses in the surveillance area.

To determine the distance of a target object based on the time of flight principle, individual laser pulses are emitted one after the other with a frequency that is limited upwards by the maximum expected travel time of a laser pulse. The travel time of a laser pulse corresponds to the time between the transmission of the laser pulse and its time of reception. The time of reception is determined by the occurrence of a certain characteristic, for example a maximum, of a useful signal component in the receiver signal caused by the received reflected portion of the laser pulse. Knowing the respective position of the deflection unit and the spatial orientation of the transmitter and receiver units at a point in time of the emission of a laser pulse and the corresponding determined distance, a three-dimensional depth profile can be created over the surveillance area. The position of the deflection unit is usually determined, for a line scanner, by a horizontal angle in a scanning plane around an axis of rotation or, for a matrix scanner, by a horizontal angle in a scanning plane around an axis of rotation and a vertical angle in a cross-scan plane around a second axis of rotation in a coordinate system. With the laser pulse frequency selected, the spatial resolution decreases with increasing scanning speed and increasing distance of the expected target objects in the setting. At the same time, depending on the scanning speed, the reception divergence or the size of the receiver surface of the receiver unit in the scanning direction must be selected in such a way that a portion of the laser pulse reflected at the target object is detected by the receiver unit, although the receiver unit is moved at the scanning speed relative to the target object. This problem is also mentioned in patent no. EP 2,998,700 B1, which is discussed in more detail below. However, a larger receiver area and a larger reception divergence result in more constant light (ambient light, extraneous light) impinging on the receiver area and increasingly influencing the receiver signal formed by the receiver unit. For the purposes of this description, a receiver signal is understood to be an amplitude signal that is formed over the reception time of the receiver unit by the useful signal component and a noise signal component caused (among other things) by the constant light. Detecting the useful signal component or a characteristic of the useful signal component in a single receiver signal requires at least that the amplitude caused by the useful signal component in the receiver signal is higher than the highest amplitude caused by the noise signal component, which is not the case for very large distances.

Typical measures to reduce the influence of constant light include placing a narrow-band optical filter in front of the receiver surface of the receiver unit, which filter has a maximum transmission in the spectral range of the emitted laser pulse, and selecting the receiver unit with an adapted spectral sensitivity as well as adapting the spectral bandwidth of the amplifier to the spectrum of the laser pulse. For greater distances, from which a reflected useful signal component only has a comparatively small amplitude, which can already be the case at a distance of approx. 50 m, these measures are often not sufficient.

In order to improve the evaluability of a receiver signal, it is known for one-dimensionally measuring laser distance measuring devices, which are stationary at least during the measurement, to direct several laser pulses successively at the same target object and then to accumulate the individual receiver signals. Due to the addition of the receiver signals with, in this case, virtually equal amplitudes of the useful signal component (signal) and random amplitudes of the noise signal component, which have different signs in relation to a mean value, the accumulated receiver signal has a clearly better signal-to-noise ratio than a single receiver signal.

DE 10 2011 054 451 A1 discloses a method and a device for optical distance measurement over large distance ranges, in which second laser pulses suitable for evaluation according to the sampling method are emitted if no reception times can be derived when evaluating the receiver signals according to the threshold method caused by a first laser pulse. This means that for distance measurements in the close range, from high amplitudes of the useful signal components, the time of reception can be determined from the receiver signals using the threshold method, which provides more accurate results. For measurements in the far range, the time of reception can be determined from small amplitudes of the useful signal components, for which an evaluation via the threshold method does not work, via the sampling method from the receiver signals by means of an accumulation of sampled receiver signals.

The requirement for a long range (great distance of the target objects) is not the same as the requirement for a large distance range (target objects at very different distances). A large distance range requires a large dynamic range, and there is no stringent need to also take measures to suppress constant light if the amplitude of the useful signal component is sufficiently high. On the other hand, for a distance meter with a long range, if the expected target objects are all within a great measuring distance, only a small dynamic range may be sufficient, but it may then be necessary to take measures to minimise the influence of constant light on the receiver signal or to improve the evaluability of the receiver signal.

The evaluation of receiver signals via the sampling method and the improvement of their evaluability by accumulation of receiver signals are described in the aforementioned DE 10 2011 054 451 A1. For evaluation, the analog receiver signal is sampled and digitised samples are formed, each of them being assigned to one of the sampling times and, in their entirety, forming a digitised sampled signal. By accumulation, i.e. repeated chronologically synchronous sampling and addition of associated digitised samples of successive receiver signals, an accumulated receiver signal is formed. The accumulated receiver signal has a better signal-to-noise ratio SNR than the individual receiver signals and thus allows the range to be increased. The improvement of the SNR is proportional to the square root of the number of individual receiver signals forming the accumulated receiver signal.

The possibility of accumulating receiver signals that are formed temporally one after the other is known from the prior art, where it is limited to stationary transmitting and receiving systems, since in systems with beam deflection and a receiver with a usually small reception divergence due to a desired high spatial resolution, the same target object is not measured several times in succession.

No laser scanning device and no method using a laser scanning device could be found in the prior art in which an improved evaluability of receiver signals is created via an accumulation of receiver signals.

A large number of laser scanning devices known from the prior art are intended to cover a wide dynamic range.

Typical areas of application for such laser scanning devices are surveillance technology in industry and in vehicles, where objects can be located within the monitored area at distances ranging from a few centimeters to several tens of meters. Accordingly, the dynamic range within which a receiver signal on the one hand does not lead to overmodulation, but on the other hand can still be formed, has to be very large. The requirement for a large dynamic range also applies if the target objects have different surfaces and thus very different remission behavior. Several individual solutions disclosed in the prior art, which have a large dynamic range, also lead to an improvement of the signal-to-noise ratio between the actual useful signal component, caused by the portion of a laser pulse reflected at the target object, and a noise signal component superimposed on this useful signal component.

U.S. Pat. No. 5,311,353 A discloses a wide dynamic range optical receiver in which a first linear amplifier and a second logarithmic amplifier are provided. The two amplifier signals formed are either added together or one of the two amplifier signals is selected for evaluation. Thus, weak receiver signals lie within the dynamic range of the first amplifier and are amplified linearly, while strong receiver signals lie within the dynamic range of the second amplifier and are amplified logarithmically. Both individual dynamic ranges of the amplifiers together represent the effective dynamic range of the receiver. Constant light is not mentioned as a problem here, which may be due to the fact that even at the largest expected target distances, the receiver signal is still expected to have a useful signal component that is significantly higher than the noise signal components.

The aforementioned EP 2,182,377 B1 also proposes a distance meter, in this case a distance-measuring laser scanner, with the aforementioned features of known laser scanning devices, wherein the effective dynamic range, which is too large for a single amplifier element, is divided by using two amplifiers. The receiver signal is fed in parallel to a more sensitive and to a less sensitive amplification path, which are connected to a first and a second amplifier, respectively. For digital signal evaluation and thus distance determination, the two amplification paths are routed to a common analog-to-digital converter for cost reasons, reversibly combining the two receiver signals of the amplification paths beforehand. In addition to the main concern of a large effective dynamic range, this solution is intended to have the advantage that the separate evaluation of weak and strong receiver signals allows the suppression of weak interfering signals, for example from a windshield or fog droplets, which falsify the measurement result due to an overlap with the actual useful signal.

The aforementioned EP 2,998,700 B1 addresses the actual problem that arises with regard to the quality of the receiver signals and their evaluation for scanning laser distance meters in contrast to laser distance meters with a stationary transmitter. Said problem results from a high scanning speed, which means that the receiver must be designed with a large field of view (FOV) so that the received beam reflected back from the target object impinges on the receiver or its receiver surface. However, receivers with a large field of view have the disadvantage that, accordingly, a large amount of daylight or ambient light (constant light) also impinges on the receiver. At the same time, an increasingly larger field of view leads to an increasingly lower spatial resolution of the depth profile formed by the setting in the field of view of the laser scanning device.

In the aforementioned EP 2,998,700 B1, a distance measuring method and an optoelectronic distance meter suitable for scanning systems are proposed with a detector that is said to be improved not only in terms of dynamic range but also in terms of signal-to-noise ratio. The detector has two independent receiving segments, each of which is provided for generating a resulting electrical receiver signal independently of the other and is designed to be assigned to predefined different distance ranges. In contrast to unsegmented detectors according to the prior art, the required effective dynamic range of the distance meter is divided into smaller dynamic ranges. By dividing the detector into independent receiving segments, the amount of background light is intended to be divided as well, which should reduce its influence on a formed receiver signal.

In a LIDAR device disclosed in US 2017/0350967 A1 and a corresponding method, a scene to be detected is detected in partial areas by scanning the scene horizontally. A receiver matrix whose pixels have a reduced reception divergence, at least in the scanning direction, is used to detect the partial areas. The reduced divergence is intended to increase the signal-to-noise ratio between the useful signal to be detected and the background light. The lower divergence further leads to better spatial resolution, which also reduces the influence of artifacts caused by glare from very bright light sources. How the low divergence affects the dynamic range of the distance measurement is not disclosed therein, especially since no measures are provided to improve the signal quality of weak useful signals from long distances.

### SUMMARY OF THE INVENTION

It is the object of the invention to find a method for the three-dimensional measurement of a setting in a large field of view and at a great distance, by which the evaluability of a receiver signal is improved. At the same time, the method is intended to improve the spatial resolution of a depth profile (distance image) of the setting generated from the receiver signals.

It is also the object of the invention to find a laser scanning device suitable to carry out the method.

The invention will be explained in more detail below with reference to exemplary embodiments and with the help of drawings, wherein:

### BRIEF DESCRIPTION OF THE DRAWINGS

The invention will be described more fully in the following with reference to embodiment examples. The drawings show:

FIG. 1 shows a schematic diagram of an exemplary embodiment of a laser scanning device according to the invention;

FIG. 2 shows a view of an exemplary arrangement of two receiver units and four transmitter units, each having two transmission channels, and

FIG. 3 shows a simplified schematic view of the process sequence.

### DETAILED DESCRIPTION

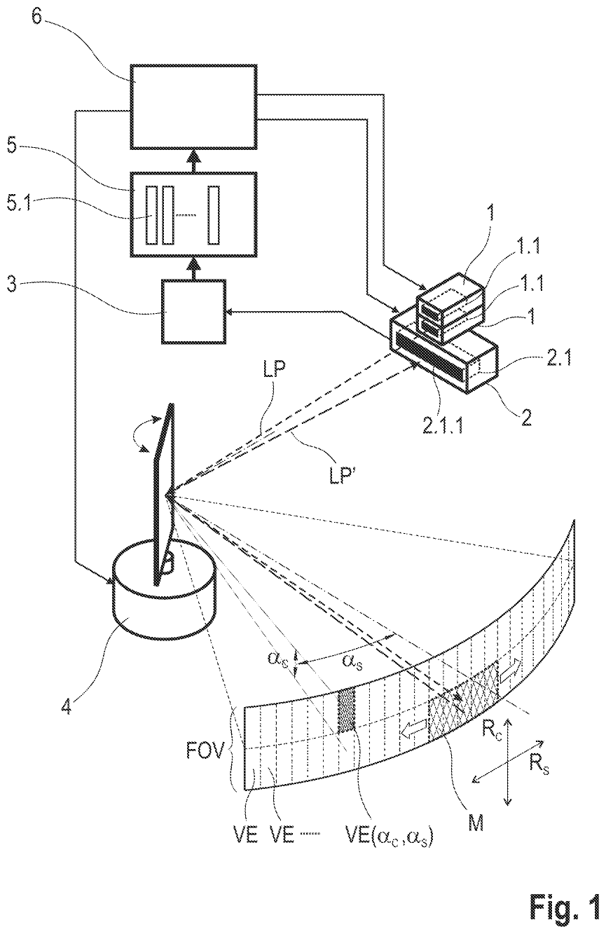

FIG. 1 shows an exemplary embodiment of a laser scanning device according to the invention for the three-dimensional measurement of a setting in a field of view FOV at a great distance. A great distance is understood to be a distance from which a reflected and detected portion LP′ of a laser pulse LP causes a useful signal component SN in a receiver signal S that does not stand out from a noise signal component SR caused by constant light. Depending on the reflectivity of the setting, this can already be the case at a distance of approx. 50 m.

The laser scanning device comprises at least one transmitter unit 1, having at least one transmission channel 1.1, for transmitting laser pulses LP in a sequence and at least one receiver unit 2, having a receiver channel 2.1, which has a receiver surface 2.1.1, for receiving portions LP′ of the laser pulses LP reflected back from measurement fields M of the setting in a sequence and for forming receiver signals S. The optionally several transmission channels 1.1 are arranged next to each other in a cross-scan direction R_{C}.

For a simple description of the mode of operation and for a clear representation, the laser scanning device shown as a schematic diagram in FIG. 1 has two transmitter units 1, each with a transmission channel 1.1, and a receiver unit 2 as an example.

A laser scanning device according to the invention, like the prior art laser scanning devices of the same generic type, generally also has an analog-to-digital converter 3 for digitizing the receiver signals S, a deflection unit 4 for scanning the laser pulses LP in a scanning direction R_{S}, a memory and evaluation unit 5, and a control unit 6.

It is essential to the invention that the transmission channels 1.1 are designed so that the emitted laser pulses LP have a rectangular beam cross-section, and that the receiver surface 2.1.1 is rectangular. Furthermore, it is essential to the invention that an emission divergence of the transmission channels 1.1 and a reception divergence of the receiver channels 2.1 in the scanning direction R_{S} are each multiple times greater than an emission divergence of the transmission channels 1.1 and a reception divergence of the receiver channels 2.1 in the cross-scan direction R_{C} perpendicular to the scanning direction R_{S}. As a result, a measurement field M in the field of view FOV, which is impinged by one of the laser pulses LP in each case, obtains a rectangular shape with a larger extension in the scanning direction R_{S}.

It is also essential to the invention that the memory and evaluation unit 5 contains a plurality of memory and evaluation areas 5.1 for parallel storage of digitized receiver signals SD and for formation of several accumulated receiver signals SA, from each of which a distance can be derived via algorithms known to the person skilled in the art.

Advantageously, the emission and reception divergences in the scanning direction R_{S} are at least three times the emission and reception divergences in the cross-scan direction R_{C} in order to achieve a high overlap of the measurement fields M even at a high scanning speed.

Since the emission divergence and the reception divergence are the same in the scanning direction R_{S} and the cross-scan direction R_{C}, the measurement field M is advantageously not restricted by the smaller divergence in either direction.

The added emission divergence of all transmission channels 1.1 in the cross-scan direction R_{C} is determinative for the size of the field of view FOV in the cross-scan direction R_{C}, while the emission divergence in the scanning direction R_{S} and the scan angle by which the deflection unit 4 can be deflected about a rotation axis are determinative for the size of the view angle of the field of view FOV in the scanning direction R_{S}.

The size of the respective measurement fields M impinged by a laser pulse LP depends on the emission and reception divergences of the transmission and receiver channels 1.1, 2.1 and the distance of the setting in the angular range thus limited. All measurement fields M together form the field of view FOV.

The number of transmission channels 1.1 determines the number of measurement fields M lying one above the other in the cross-scan direction R_{C}. According to the embodiment example shown in FIG. 1, there are two transmitter units 1, each with a transmission channel 1.1, whose emission divergences are matched to the reception divergences of the receiver channel 2.1 of the one receiver unit 2. The transmitter units 1 are controlled continuously in alternation, so that during a scan (one-time scanning of the field of view FOV), the field of view FOV is scanned quasi simultaneously in two lines. Since the two transmitter units 1 are controlled one after the other, they can both be assigned to the only one receiver channel 2.1, with the reception divergence of the one receiver channel 2.1 in the cross-scan direction R_{C} being equal to or greater than a resulting emission divergence of the two transmission channels 1.1 in the cross-scan direction R_{C}.

There may also be two or more receiver units 2, which are arranged next to each other in the cross-scan direction R_{C} and to each of which one or more transmission channels 1.1 are assigned, and if there are several transmission channels 1.1, these belong to different transmitter units 1.

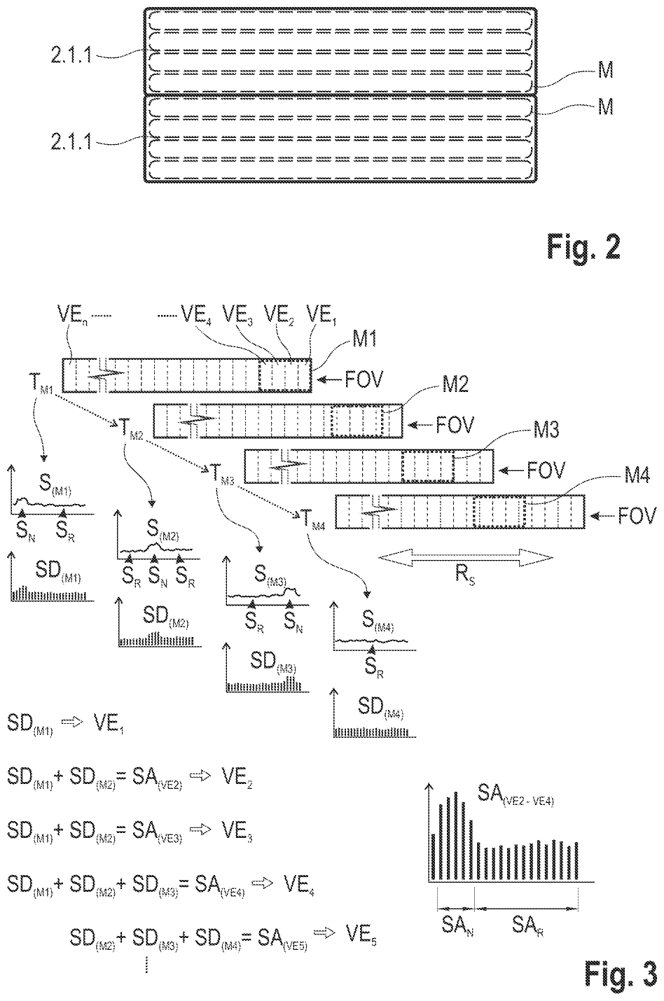

FIG. 2 shows an example of an arrangement of two receiver units 2, represented by the receiver surfaces 2.1.1, and four transmitter units 1, each with two transmission channels 1.1, represented by eight measuring surfaces M projected onto the receiver surfaces 2.1.1. In this case, one transmission channel 1.1 from each of the four transmitter units 1 is assigned to one of the receiver surfaces 2.1.1, so that the measuring surfaces M projected onto one receiver surface in each case are illuminated by the four transmitter units 1. With this arrangement, a field of view FOV resolved into eight lines can be scanned quasi-simultaneously during a scan. The transmitter units 1 are controlled consecutively in this case. After beam splitting, the laser pulse LP emitted in each case is directed via two transmission channels 1.1 into the field of view FOV, where different measurement fields M are impinged and the reflected portions LP′ of the laser pulse LP are received in each case by one of the two receiver units 2.

The spatial resolution of the field of view FOV in the cross-scan direction R_{C} is determined by the emission and reception divergence in the cross-scan direction R_{C}. In the scanning direction R_{S}, the spatial resolution is determined by the signal processing of the receiver signals S according to the invention, largely independently of the scanning speed and pulse frequency at which the laser pulses LP are emitted and scan the field of view FOV.

Signal processing is a process step of the method according to the invention described below.

With a method according to the invention, a three-dimensional measurement is performed of a setting in a field of view FOV is performed at a large distance. As with prior art processes of the same generic type:
1. laser pulses LP are emitted in a continuous sequence one after the other via at least one transmission channel 1.1, which has an emission divergence in a scanning direction R_{S} and a cross-scan direction R_{C} respectively,
2. after reflection of the laser pulses LP in a measurement field M in the setting, respective reflected portions LP′ of the laser pulses LP are received successively via at least one receiver channel 2.1 which has a reception divergence in the scanning direction R_{S} and the cross-scanning direction R_{C} respectively, and
3. a receiver signal S is formed, amplified and digitized over the travel time of each of the portions LP′ of the laser pulses LP, while the laser pulses LP are scanned in the scanning direction R_{S}, wherein a different measurement field M is detected with each laser pulse LP in the field of view FOV, depending on a scanning speed and a pulse frequency.

In connection with the method, it is essential to the invention that the field of view FOV is divided into virtual receiver cells VE forming a row or a matrix, each of said virtual receiver cells VE being characterized by a virtual divergence angle about an imaginary center axis, which is multiple times smaller than the emission and reception divergence in the scanning direction R_{S}, so that several virtual receiver cells VE are located simultaneously within one of the measurement fields M. The spatial positions of the center axes of the virtual receiver cells VE are each characterized by an angle as in the scanning direction R_{S} and an angle α_{C} in the cross-scan direction R_{C}, as shown by the example of a virtual receiver cell VE(α_{C}, α_{S}) in FIG. 1.

The digitized receiver signals SD are respectively assigned to each of the virtual receiver cells VE located within one of the measurement fields M, and the scanning speed and the pulse frequency are matched to each other such that the measurement fields M overlap in the scanning direction R_{S}, so that each virtual receiver cell VE is assigned a plurality of successive digitized receiver signals SD, from which an accumulated receiver signal SA with an accumulated useful signal component SAN, from which a distance is derived, is formed for each of the virtual receiver cells VE.

Virtual receiver cells VE only partially located in the measurement field M are either considered to be located in the measurement field M or to be located outside the measurement field M.

In practice, the memory and evaluation unit 5 of a laser scanning device used to carry out the method can contain several memory and evaluation areas 5.1 for this purpose. Their number is at least equal to the number of virtual receiver cells VE respectively located in a measurement field M.

Each memory and evaluation area 5.1 is then assigned to one of the virtual receiver cells VE. The digitized receiver signals SD are each stored in parallel in those memory and evaluation areas 5.1 which are assigned to virtual receiver cells VE that lie within the measurement field M belonging to the digitized receiver signal SD. Accumulated receiver signals SA are formed from the digitized receiver signals VE stored in each case by a memory and evaluation unit 5, from which accumulated receiver signals SA a distance assigned to one of the virtual receiver cells VE is derived in each case.

For the sake of a clear representation, FIG. 3 shows the field of view FOV, which is divided here into a row of virtual receiver cells VE, at four successive times T_{M1}-T_{M4}, at each of which the position of the measurement field M has changed significantly. In practice, the scanning speed is only such that, preferably, more than 20 digitized receiver signals SD are accumulated per virtual receiver cell VE. By scanning the laser pulses LP in the scanning direction R_{S}, a different measurement field M1-M4 is illuminated in the field of view FOV at each of these times. The receiver signals S_{(M1)}-S_{(M4)} obtained in each case from the reflected portion LP′ of each laser pulse LP are converted into digitized receiver signals SD_{(M1)} to SD_{(M4)} and accumulated with further digitized receiver signals SD_{(M1)}-SD_{(M4)} to form in each case an accumulated receiver signal SA_{(VE2)}-SA_{(VE4)} assigned to one of the virtual receiver cells VE₂-VE₄. The signal curves shown in FIG. 3 are only symbolic. Likewise, the number of virtual receiver cells VE covered per measurement field M and the offset of measurement fields M successively generated in the scanning direction R_{S} only serve as examples. The more digitized receiver signals SD can be accumulated, the better the signal-to-noise ratio between the accumulated noise signal component SAR and the accumulated useful signal component SAN. The narrower the virtual receiver cells VE are selected, i.e. the smaller the angular range of the field of view FOV assigned to them in the scanning direction R_{S}, the more the spatial resolution capability in the scanning direction R_{S} is improved.

### LIST OF REFERENCE NUMERALS

1 transmitter unit
1.1 transmission channel
2 receiver unit
2.1 receiver channel
2.1.1 receiver surface
3 analog-to-digital converter
4 deflection unit
5 memory and evaluation unit
5.1 memory and evaluation areas
6 control unit
LP laser pulse
LP′ (back)reflected and detected portion of the laser pulse LP
S receiver signal
SD digitized receiver signal
SA accumulated receiver signal
SN useful signal component of the receiver signal S
SAN accumulated useful signal component
SN noise signal component of the receiver signal S
SAR accumulated noise signal component
FOV field of view
M measurement field
VE virtual receiver cell
R_{S} scanning direction
R_{C} cross-scan direction
T points in time at which laser pulses LP are emitted

1. A laser scanning device for the three-dimensional measurement of a setting in a field of view at a great distance, comprising:
at least one transmitter unit having at least one transmission channel for transmitting laser pulses in a sequence;
at least one receiver unit having a receiver channel, which has a receiver surface, for receiving portions of the laser pulses reflected back from measurement fields of the setting in a sequence and for forming receiver signals;
an analog-to-digital converter for digitizing the receiver signals, and a deflection unit for scanning the transmitter unit and the receiver unit, in a scanning direction, the receiver unit being arranged in a fixed relative position to the transmitter unit;
a memory and evaluation unit; and
a control unit;
wherein the laser pulses have a rectangular beam cross-section, the receiver surface is rectangular, an emission divergence of the at least one transmission channel and a reception divergence of the at least one receiver channel in the scanning direction are in each case multiple times greater than an emission divergence of the at least one transmission channel and a reception divergence of the at least one receiver channel in a cross-scan direction, and the memory and evaluation unit contains a plurality of memory and evaluation areas for parallel storage of digitized receiver signals and formation of accumulated receiver signals from which a distance can be derived in each case.

2. The laser scanning device according to claim 1, wherein the emission and reception divergences in the scanning direction are at least three times the emission and reception divergences in the cross-scan direction.

3. The laser scanning device according to claim 2, wherein the emission divergence and the reception divergence in the scanning direction are equal.

4. The laser scanning device according to claim 1, wherein several transmission channels are assigned to the at least one receiver unit, with the reception divergence of the at least one receiver channel in the cross-scan direction being equal to or greater than a resulting emission divergence of the plurality of transmission channels in the cross-scan direction.

5. The laser scanning device according to claim 4, wherein at least two receiver units are present, which are arranged next to each other in the cross-scan direction.

6. A method for the three-dimensional measurement of a setting in a field of view at a great distance, comprising:
emitting laser pulses in a continuous sequence one after the other via at least one transmission channel of at least one transmitter unit, which transmission channel has an emission divergence in a scanning direction and a cross-scan direction in each case,
after reflection in the setting, receiving reflected portions of the laser pulses via at least one receiver unit with a receiver channel which has a respective reception divergence in the scanning direction and the cross-scan direction, and
forming and amplifying a receiver signal over the travel time of each of the portions of the laser pulses and forming a digitized receiver signal therefrom, while the laser pulses are scanned in the scanning direction and a different measurement field is detected with each laser pulse in the field of view, depending on a scanning speed and a pulse frequency,
dividing the field of view into virtual receiver cells forming a row or a matrix, each of said virtual receiver cells being characterized by a virtual divergence angle about an imaginary center axis, which is multiple times smaller than the emission and reception divergence in the scanning direction, so that several virtual receiver cells are located simultaneously within one of the measurement fields, and
respectively assigning in that the digitized receiver signals to each of the virtual receiver cells located within one of the measurement fields, and matching the scanning speed and the pulse frequency to each other such that the measurement fields overlap in the scanning direction so that each virtual receiver cell is assigned a plurality of successive digitized receiver signals, from which an accumulated receiver signal with an accumulated useful signal component, from which a distance is derived, is formed for each of the virtual receiver cells.
